(19) United States
(12) Patent Application Publication
(10) Pub. No.: US 2025/0286495 A1
(43) Pub. Date: Sep. 11, 2025

(54) HIGH SPEED BUS VOLTAGE CLAMP FOR POWER TOOL MOTOR DRIVE

(71) Applicant: MILWAUKEE ELECTRIC TOOL CORPORATION, Brookfield, WI (US)

(72) Inventor: Donald J. Truettner, Waukesha, WI (US)

(21) Appl. No.: 19/061,347

(22) Filed: Feb. 24, 2025

Related U.S. Application Data
(60) Provisional application No. 63/562,577, filed on Mar. 7, 2024.
(60) Provisional application No. 63/666,542, filed on Jul. 1, 2024.

(51) Int. Cl. H02P 29/024; B25F 5/02

(52) U.S. Cl. CPC H02P 29/0241; B25F 5/02

(57) ABSTRACT

A power tool comprising, a motor, a DC bus configured to provide operating power to the motor, a source inductor electrically connected to the DC bus, a voltage clamp provided across the DC bus and configured to be selectively activated, and a controller electrically connected to the voltage clamp. The controller is configured to determine that a voltage across the DC bus is greater than a predetermined threshold and activate the voltage clamp in response to the voltage across the DC bus being greater than the predetermined threshold.

### CROSS-REFERENCE TO RELATED APPLICATIONS

This application claims priority to U.S. Provisional Patent Application No. 63/666,542, filed Jul. 1, 2024, and U.S. Provisional Patent Application No. 63/562,577, filed Mar. 7, 2024, the entire contents of both of which are incorporated herein by reference.

### FIELD

The present disclosure relates to a power tool motor drive during shutdown of a power tool.

### BACKGROUND

Energy becomes trapped in direct-current (DC) power tools when there is a controlled or uncontrolled shutdown, which runs the risk of an overvoltage condition damaging the DC power tool. For example, energy becomes trapped in either the source, load, or both. Traditionally, power tools include DC bus capacitors to absorb the trapped energy.

### SUMMARY

During a controlled or uncontrolled shutdown of a DC power tool, the magnitude of a DC bus voltage needs to be limited so as to not create an overvoltage condition on the DC bus. However, some power tools include multiple capacitors as an energy reservoir to absorb energy that is trapped during a shutdown of the power tool. Capacitors on the DC bus occupy precious space in power tools that are increasingly becoming smaller and more efficient in design. Additionally, capacitors have a parasitic component to them that limits the speed at which they can respond to energy being trapped on the DC bus. Accordingly, there is a need for trapped energy converting solutions that are smaller, lighter, faster, and more efficient for power tools. For example, a transistor is able to facilitate the trapped energy to a power dissipating device that converts the trapped energy into heat, allowing for the DC bus voltage to be at an acceptable level. The single transistor and power dissipating device saves space and provides faster response times compared to the traditional capacitors used as energy reservoirs.

One embodiment of the present invention discloses a power tool comprising, a motor, a DC bus configured to provide operating power to the motor, a source inductor electrically connected to the DC bus, a voltage clamp provided across the DC bus and configured to be selectively activated, and a controller electrically connected to the voltage clamp. The controller is configured to determine that a voltage across the DC bus is greater than a predetermined threshold and activate the voltage clamp in response to the voltage across the DC bus being greater than the predetermined threshold.

A further embodiment of the present invention discloses a method for converting trapped energy in a power tool to heat. The method comprises determining, using a controller, that a voltage across a DC bus of the power tool is greater than a predetermined threshold and activating, using the controller, a voltage clamp connected across the DC bus in response to the voltage being greater than the predetermined threshold.

An even further embodiment of the present invention discloses a power circuit for providing power to a switching network to control a motor. The power circuit comprises a DC bus, a source inductor electrically connected to the DC bus, a voltage clamp, and a controller electrically connected to the DC bus, the source inductor, and the voltage clamp. The controller is configured to determine that a voltage across the DC bus is greater than a predetermined threshold and activate the voltage clamp in response to the voltage across the DC bus being greater than the predetermined threshold.

Other aspects of the embodiments will become apparent by consideration of the detailed description and accompanying drawings.

### BRIEF DESCRIPTION OF THE DRAWINGS

FIG. 1 is a perspective view of a power tool, according to some embodiments.

FIG. 2 is a perspective view of a battery pack for powering the power tool of FIG. 1, according to some embodiments.

FIG. 3A is a first simplified block diagram of a power circuit of the power tool of FIG. 1, according to some embodiments.

FIG. 3B is a second simplified block diagram of a power circuit of the power tool of FIG. 1, according to some embodiments.

FIG. 4 is a simplified block diagram of a voltage clamp of the power circuit of FIG. 3, according to some embodiments.

FIG. 5 is a simplified block diagram of a controller of the power tool of FIG. 1, according to some embodiments.

FIG. 6 is a flowchart illustrating a method of voltage clamping of a power tool, according to some embodiments.

Before any embodiments are explained in detail, it is to be understood that the embodiments are not limited in their application to the details of construction and the arrangement of components set forth in the following description or illustrated in the following drawings. The embodiments are capable of being practiced or of being carried out in various ways. Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Additionally, unless otherwise noted, terms of approximation, such as “about,” approximately,” and “substantially,” at least when used with numerical values, may refer to within 1%, 2.5%, 5%, or 10% of the noted value.

### DETAILED DESCRIPTION

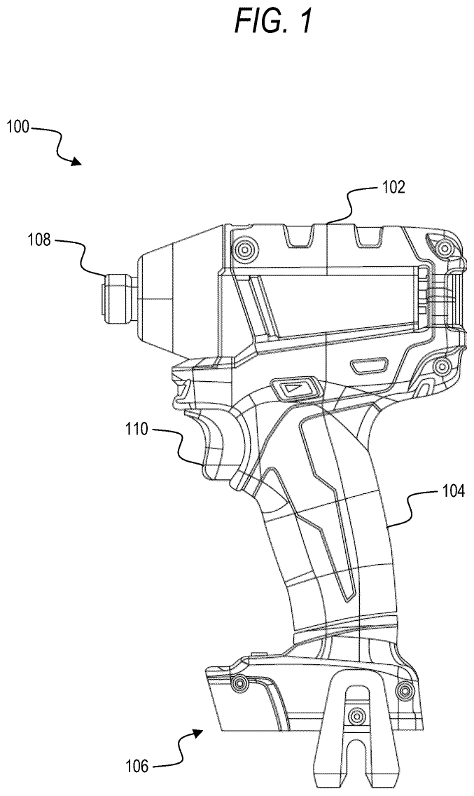

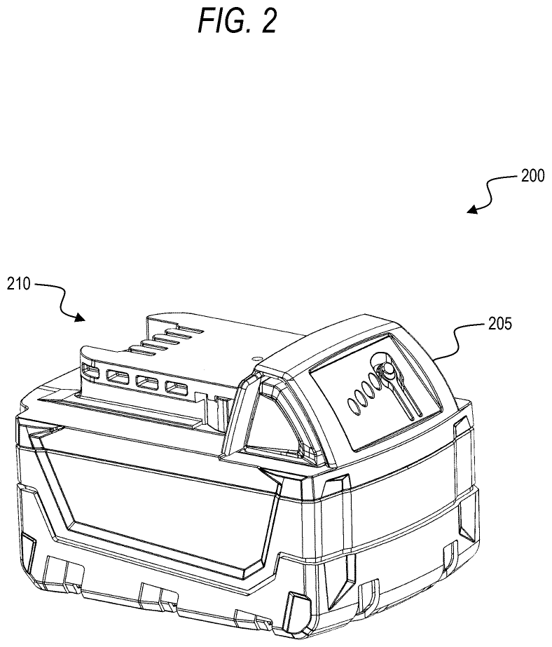

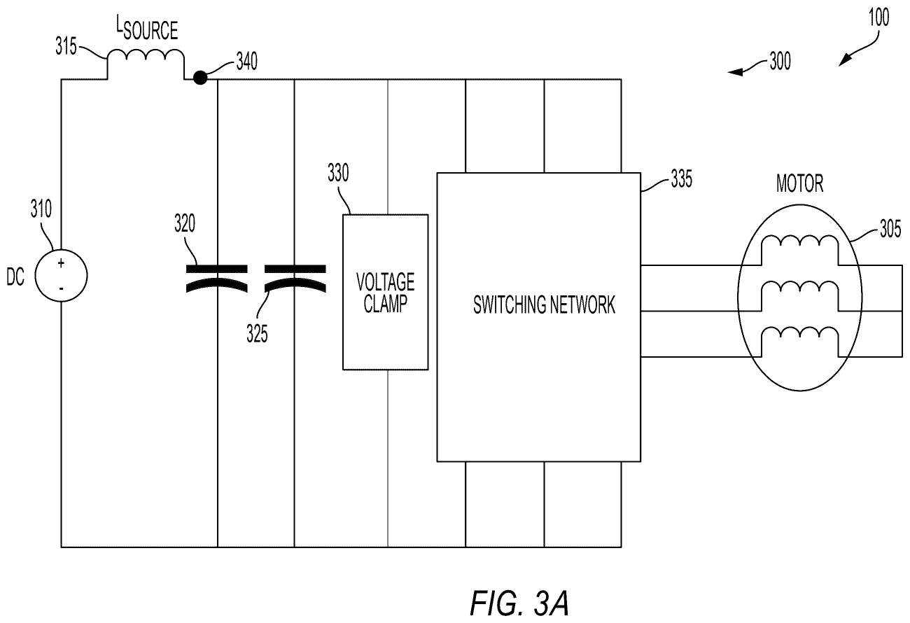

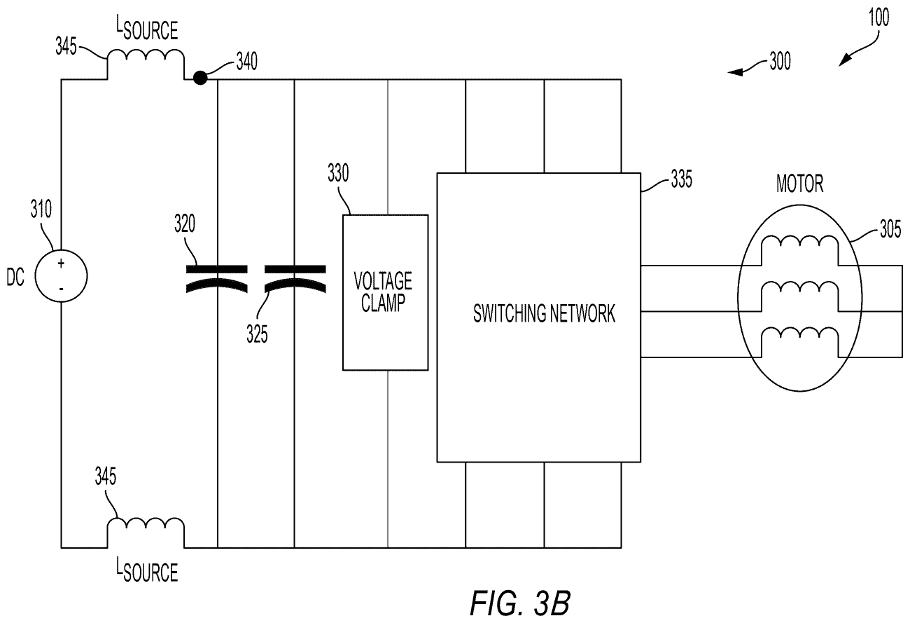

FIG. 1 illustrates an embodiment of a power tool 100 including a brushless direct current (“BLDC”) motor. The power tool 100 is, for example, an impact driver including an upper main body 102, a handle 104, a battery pack receiving portion 106, an output drive device or mechanism 108, and a trigger 110. The power tool 100 further includes a motor, such as motor 305 (FIG. 3) within the main body 102 of the housing and having a rotor and a stator. The rotor is coupled to a motor shaft arranged to produce an output outside of the housing via the output drive device or mechanism 108. The housing of the power tool 100 (e.g., the main body 102 and the handle 104) are composed of a durable and light-weight plastic material. The drive device 108 is composed of a metal (e.g., steel) output spindle. The battery pack receiving portion 106 is configured to receive and couple to a battery pack, such as a battery pack 200 (FIG. 2) that provides power to the power tool 100. The battery pack receiving portion 106 includes a connecting structure to engage a mechanism that secures the battery pack and a terminal block to electrically connect the battery pack 200 to the power tool 100. In some embodiments, the power tool 100 may be an alternating current (AC) powered power tool that includes a rectifier to provide a DC voltage to the motor 305.

FIG. 1 illustrates an impact wrench, however, the power tool 100 may include drills, circular saws, jig saws, band saws, reciprocating saws, screw drivers, angle grinders, straight grinders, hammers, multi-tools, impact wrenches, rotary hammers, impact drivers, angle drills, powered ratchets, powered torque wrenches, hydraulic pulse tools, hydraulic tensioning tools, lock bolt installation tools, reaction arm tools, riveting tools, nailers, staplers, TC bolt guns, and the like.

FIG. 2 illustrates a battery pack 200, according to some embodiments. The battery pack 200 is a power tool battery pack that is generally used to power a power tool, such as the power tool 100. The battery pack 200 includes a housing 205 and an interface portion 210 for connecting the battery pack 200 to a device (e.g., the power tool 100). In some embodiments, the battery pack 200 includes lithium ion battery cells. In other embodiments, the battery pack 200 may be of a different chemistry, for example, nickel-cadmium, nickel-metal hydride, and the like. In the illustrated embodiment, the battery pack 200 is an 18 volt battery pack. In other embodiments, the output voltage level of the battery pack 200 may be different. For example, the battery pack 200 can be a 4 volt battery pack, 28 volt battery pack, 36 volt battery pack, 72 volt battery pack or another voltage (voltage here may refer to nominal voltage). The battery pack 200 may also have various capacities (e.g., 3, 4, 5, 6, 8, or 12 ampere-hours).

The battery pack 200 also includes terminals to connect to the power tool 100. The terminals for the battery pack 200 includes a positive and a negative terminal to provide power to and from the battery pack 200. In some embodiments, the battery pack 200 also includes data terminals to communicate with the power tool 100. For example, the battery pack 200 may include a microcontroller to monitor one or more characteristics of the battery pack 200 and the data terminals may communicate with the power tool 100 regarding the monitored characteristics.

FIG. 3A is a first simplified block diagram of the power tool 100 including a power circuit 300 of the power tool 100, according to some embodiments. The circuit 300 includes a motor 305, a power source 310, a source inductor 315, a first capacitor 320, a second capacitor 325, a voltage clamp 330, a switching network 335, and a DC bus 340. In some embodiments, the motor 305 is a brushless DC (BLDC) motor. In some embodiments, the power source 310 is a battery pack, such as the battery pack 200. The power source 310 provides direct current (DC) operating voltage to the DC bus 340, which is then provided to the motor 305 (e.g., motor coils) through the switching network 335. Alternatively, in some embodiments, the power source 310 is an AC power source and a rectifier is provided that turns AC power into DC power that is provided to the DC bus 340. The first capacitor 320 and the second capacitor 325 (collectively referred to as “the capacitors 320, 325”) are both coupled in parallel with each other and in parallel with the voltage clamp 330 and the switching network 335. The source inductor 315 is coupled in series with the power source 310. The source inductor 315 is coupled on one end to a positive side of the power source 310. The source inductor 315 is coupled on another end to the capacitors 320, 325, the voltage clamp 330, and the switching network 335. The source inductor 315 may have a first inductance value. The voltage clamp 330 is provided in parallel with the power source 310, the source inductor 315, the capacitors 320, 325, and the switching network 335. The switching network is provided in parallel with the power source 310, the source inductor 315, the capacitors 320, 325, the voltage clamp 330, and the motor 305. The voltage clamp 330 and the switching network 335 will be described below.

FIG. 3B is a second first simplified block diagram of the power tool 100 including a power circuit 300 of the power tool 100, according to some embodiments. The circuit 300 includes a motor 305, a power source 310, a first capacitor 320, a second capacitor 325, a voltage clamp 330, a switching network 335, a DC bus 340, and two source inductors 345. In some embodiments, the motor 305 is a brushless DC (BLDC) motor. In some embodiments, the power source 310 is a battery pack, such as the battery pack 200. The power source 310 provides direct current (DC) operating voltage to the DC bus 340, which is then provided to the motor 305 (e.g., motor coils) through the switching network 335. Alternatively, in some embodiments, the power source 310 is an AC power source and a rectifier is provided that turns AC power into DC power that is provided to the DC bus 340. The first capacitor 320 and the second capacitor 325 (collectively referred to as “the capacitors 320, 325”) are both coupled in parallel with each other and in parallel with the voltage clamp 330 and the switching network 335. A first source inductor 345 is coupled in series with the power source 310 at a positive end of the power source 310 and a second source inductor 345 is coupled in series with the power source 310 at a negative end of the power source 310. The first source inductor 345 is coupled on another end to the capacitors 320, 325, the voltage clamp 330, and the switching network 335. The second source inductor 345 is also coupled on another end to the capacitors 320, 325, the voltage clamp 330, and the switching network 335. The two source inductors 345 may both be the first inductance value, or they may both be a second inductance value that is equal to one half of the first inductance value (e.g., such that multiplying the second inductance value by two equals the first inductance value). The voltage clamp 330 is provided in parallel with the power source 310, the two source inductors 345, the capacitors 320, 325, and the switching network 335. The switching network is provided in parallel with the power source 310, the two source inductors 345, the capacitors 320, 325, the voltage clamp 330, and the motor 305. The voltage clamp 330 and the switching network 335 will be described below.

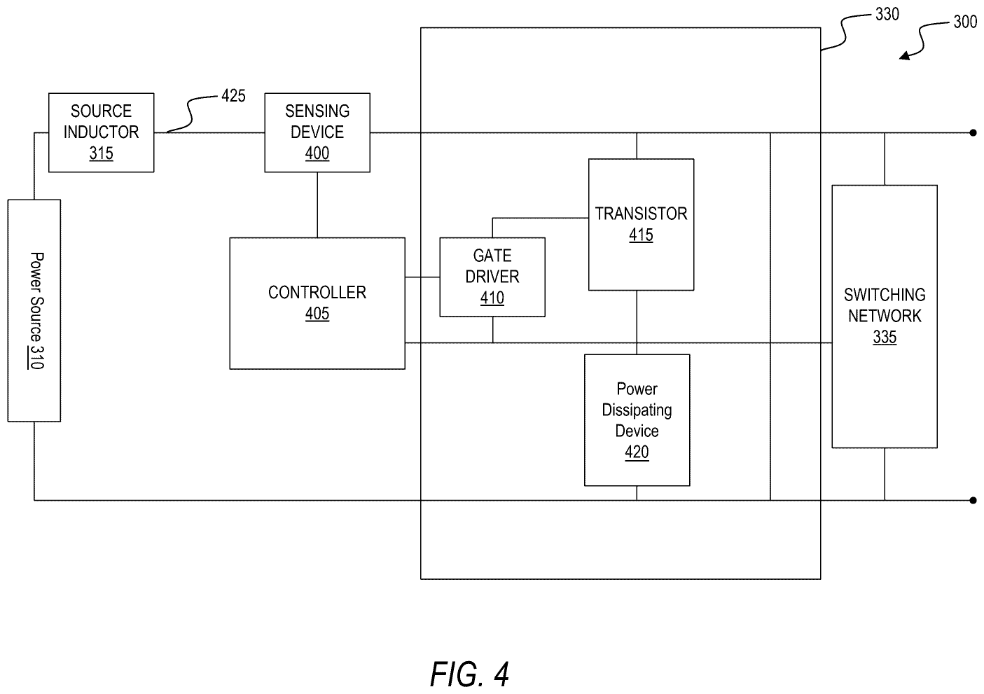

FIG. 4 is a simplified block diagram of the voltage clamp 330 (e.g., voltage clamp circuit) of the power circuit 300, according to some embodiments. The power tool 100 further includes a sensing device 400 and a controller 405. The voltage clamp 330 includes a gate driver 410, a transistor 415, and a power dissipating device 420. The power dissipating device may be a resistor, a transient voltage suppressor (TVS) diode, a metal-oxide varistor (MOV), and the like. The sensing device 400 is connected to the DC bus 340 and is configured to detect a DC bus voltage across the DC bus 340. In some embodiments, the sensing device 400 provides first sensor data related to the DC bus voltage to the controller 405. Based upon input from the sensing device 400, the controller 405 may output a signal to the gate driver 410. In some embodiments, the gate driver 410 provides pulse width modulated (PWM) signals to the transistor 415 to switch the transistor 415 at a particular frequency with a particular duty cycle. Alternatively, in some embodiments, the gate driver 410 may send an ON signal to the transistor 415 so that it remains ON (e.g., active). When the transistor 415 is ON, the power dissipating device 420 is connected across the DC bus 340 and converts the trapped energy into heat. For example, the current flowing through the power dissipating device 420 generates heat, which may be dissipated by the power tool, for example, using a heat sink. Though shown connected to a negative side of the power source 310, the power dissipating device 420 may be connected to a positive side of the power source 310. For example, the power dissipating device 420 may swap positions with the transistor 415 such that the power dissipating device 420 is connected to a positive side of the DC bus 340 and the transistor 415 is connected to a negative side of the DC bus 340.

In some embodiments, the transistor 415 is a wide bandgap semiconductor field effect transistor (FET). Wide bandgap semiconductor FETs are made from, for example, Gallium Nitrite (GaN), Silicon Carbide (SiC), or the like, and have a bandgaps in the range of, for example, about 3-4 electronvolts (eV). Wide bandgap semiconductors exhibit several properties that provide advantages compared to traditional field-effect transistors (FETs) (e.g., MOSFETS). Particularly, wide bandgap semiconductors can be operated at very high frequencies, for example, at 100 kHz, 200 kHz, 400 kHz, and more while losing less energy as heat than MOSFETs operating at lower frequencies, for example, 25 kHz, 50 kHz, and the like. Wide bandgap semiconductors have increased response times when turned ON, compared to traditional FETs.

Because the wide bandgap semiconductors can be operated at very high frequencies, the transistor 415 provides higher resolution signals at the outputs. Energy storage capacity can be reduced for the same total output energy rating caused by the increased frequency during operation of the wide bandgap semiconductors compared to MOSFETs. Additionally, smaller heat sinks and fans can be used because the wide bandgap semiconductors operate more efficiently than MOSFETs and therefore produce less heat during operation. Accordingly, the size and weight of the components within the power tool 100 can be reduced and efficiency can be improved of the power circuit 300 by replacing MOSFETs with wide bandgap semiconductor devices within the voltage clamp 330.

The switching network 335 controls the motor 305 based on control signals from a motor controller, such as controller 405. The switching network 335 includes a plurality of electronic switches (e.g., FETs, bipolar transistors, and the like) connected together to form a network that controls the activation of the motor 305 using a pulse-width modulated (PWM) signal. For instance, the switching network 335 may include a six-FET inverter bridge that receives PWM signals from the controller 405 to drive the motor 305. Generally, when the trigger 110 is depressed, electrical current is supplied from the power source 310 to the motor 305 via the switching network 335. When the trigger 110 is not depressed, electrical current is not supplied from the power source 310 to the motor 305.

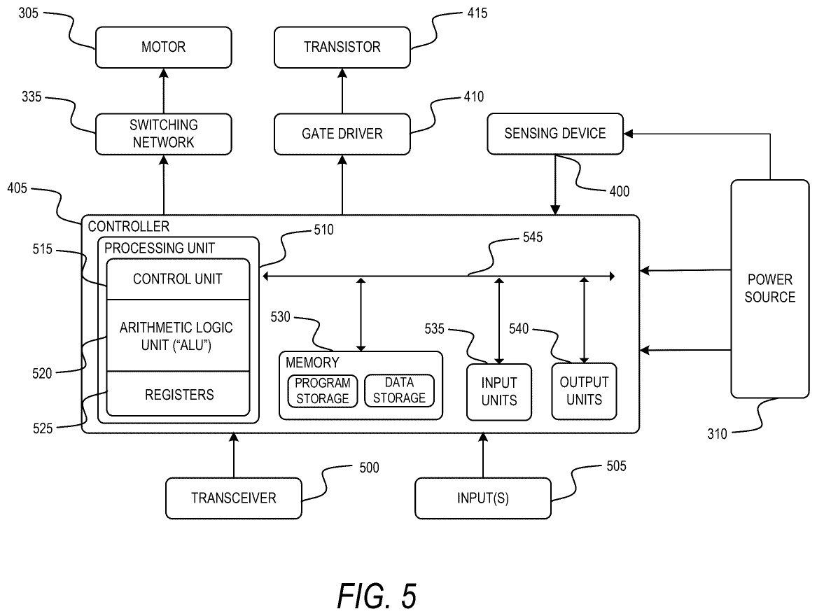

The controller 405 for the power circuit 300 is illustrated in FIG. 5. In some embodiments, the controller 405 is the controller for the whole power tool 100 (e.g., there is only a single controller in the power tool 100). Alternatively, in some embodiments, the controller 405 is specific to the power circuit 300, and in particular to the voltage clamp 330 and/or the switching network 335. The controller 405 may electrically and/or communicatively connected to a variety of modules or components of the power tool 100. For example, the illustrated controller 405 is connected to a transceiver 500, input(s) 505 (e.g., user interface, trigger switch, sensors, etc.), the power source 310, the sensing device 400, the gate driver 410, and the switching network 335.

The controller 405 includes a plurality of electrical and electronic components that provide power, operational control, and protection to the components and modules within the controller 405, the power tool 100, and/or the power circuit 300. For example, the controller 405 includes, among other things, a processing unit 510 (e.g., a microprocessor, an electronic processor, an electronic controller, a microcontroller, or another suitable programmable device), a memory 530, input units 535, and output units 540. The processing unit 510 includes, among other things, a control unit 515, an arithmetic logic unit (“ALU”) 520, and a plurality of registers 525 (shown as a group of registers in FIG. 5), and is implemented using a known computer architecture (e.g., a modified Harvard architecture, a von Neumann architecture, etc.). The processing unit 510, the memory 530, the input units 535, and the output units 540, as well as the various modules connected to the controller 405 are connected by one or more control and/or data buses (e.g., common bus 545). The control and/or data buses are shown generally in FIG. 5 for illustrative purposes. The use of one or more control and/or data buses for the interconnection between and communication among the various modules and components would be known to a person skilled in the art in view of the embodiments described herein.

The memory 530 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 510 is connected to the memory 530 and executes software instruction that are capable of being stored in a RAM of the memory 530 (e.g., during execution), a ROM of the memory 530 (e.g., on a generally permanent basis), or another non-transitory computer readable medium such as another memory or a disc. Software included in the implementation of the power tool 100 can be stored in the memory 530 of the controller 405. The software includes, for example, firmware, one or more applications, program data, filters, rules, one or more program modules, and other executable instructions. The controller 405 is configured to retrieve from the memory 530 and execute, among other things, instructions related to the control processes and methods described herein. In other embodiments, the controller 405 includes additional, fewer, or different components.

The transceiver 500 allows for wired or wireless communication between the controller 405 and other devices, for example, the power tool battery pack 200, heavy duty power tools, heavy duty battery packs, an external device (e.g., mobile phone), and the like. In some embodiments, the transceiver 500 may include both a transmitter and a receiver. In other embodiments, the transceiver 500 may include a single device for transmitting and receiving. In some embodiments, the transceiver 500 receives a threshold DC bus voltage magnitude set by a user via an external device that the controller 405 compares to the DC bus voltage to determine whether to turn on the transistor 415.

In some embodiments, the input(s) 505 include a user interface (e.g., display, actuators, etc.) and sensors (e.g., motor current sensors, motor voltage sensors, motor position sensors, temperature sensors, torque sensors, trigger pull sensors, etc.). For example, a trigger pull sensor senses the amount that the trigger 110 is pulled and the force with which the trigger is pulled. In some embodiments, the controller 405 determines a shutdown condition of the power tool 100 based on the trigger pull sensor. For example, the controller 405 may determine that the power tool 100 is no longer being operated based on a lack of input from the trigger pull sensor and/or a release of the trigger pull sensor for a predetermined amount of time.

The motor 305 may be energized based on a state of the trigger 110. Generally, when the trigger 110 is activated, the motor 305 is energized, and when the trigger 110 is deactivated, the motor 305 is de-energized. In the illustrated embodiment, the trigger 110 is biased (e.g., with a biasing member such as a spring) such that the trigger 110 moves in a second direction away from the handle of the power tool 100 when the trigger 110 is released by the user.

The switching network 335 enables the controller 405 to control the operation of the motor 305. The switching network 335 includes a plurality of electronic switches (e.g., FETs, bipolar transistors, and the like) connected together to form a network that controls the activation of the motor 305 using a pulse-width modulated (PWM) signal. For instance, the switching network 335 may include a six-FET bridge that receives PWM signals from the controller 405 to drive the motor 305.

The gate driver 410 activates the transistor 415 based on input from the controller 405. In some embodiments, the gate driver 410 is a power amplifier that receives a low-power input from the power source 310, via the controller 405 and produces a high-current drive input for the transistor 415.

Power tools, such as the power tool 100, maintain a DC bus voltage during normal operation. However, in the event of a shutdown energy may become trapped in either the source, the load, or both, creating inductance that can cause an overvoltage condition on a DC bus, such as the DC bus 340. This trapped energy can be removed as heat as further described below.

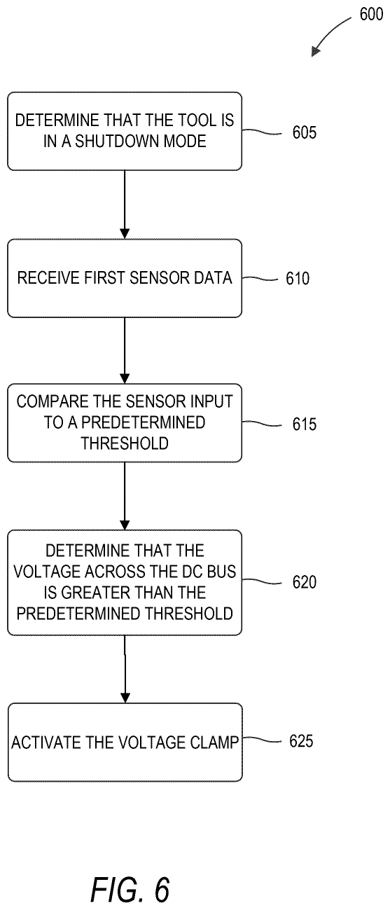

FIG. 6 illustrates a method 600 for voltage clamping of the power tool 100 according to some embodiments. Voltage clamping of the power tool 100 turns trapped energy in heat, thus mitigating any potential over voltage that could arise during a shutdown of the power tool 100. Although the illustrated method 600 includes specific steps, not all of the steps need to be performed or need to be performed in the order presented. In some embodiments, the method 600 is executed by the controller 405. The values of various thresholds or ranges described with respect to method 600 are provided as non-limiting examples and other values for such parameters are possible and may vary based on the type or condition of the power tool 100, other factors, or a combination thereof.

The method 600 includes determining, using the controller 405, that the power tool 100 is in a shutdown mode (step 605). In some embodiments, the shutdown is a controlled shutdown of the power tool 100 (e.g., turning the power tool 100 OFF). For example, a controlled shutdown of the power tool 100 may be when a user releases the trigger 110 of the power tool 100, thus, deactivating the trigger 110. The controller 405 may determine that the user released the trigger 110 based on an input from the inputs 505 (e.g., trigger pull sensor). In some embodiments, the shutdown may be an uncontrolled shutdown of the power tool 100. For example, an uncontrolled shutdown of the power tool 100 may be when the controller 405 determines an over-current condition, an over-temperature condition, a kickback condition, or the like of the power tool 100. The controller 405 determines uncontrolled shutdown of the power tool 100 based on second input data from at least one of the inputs 505 (e.g., voltage sensor, current sensor, temperature sensor, etc.). In some embodiments, when the power tool 100 shuts down, energy may become trapped in the power source 310, the source inductor 315, and/or the motor 305. When trapped energy is not dealt with, an overvoltage condition on the DC bus 425 may occur.

In step 610, the method 600 includes receiving, using the controller 405, first sensor data. In some embodiments, the controller 405 receives the first sensor data from the sensing device 400. For example, the sensing device 400 might be a voltage sensor that senses a DC bus voltage across the DC bus 425. The first sensor data is indicative of the voltage across the DC bus 425.

In step 615, the method 600 includes comparing, using the controller 405, the sensor input to a predetermined threshold. In some embodiments, the predetermined threshold is set by a user on an external device (e.g., mobile phone) via mobile application that transmits the predetermined threshold to the transceiver 500. Alternatively, or additionally, in some embodiments, the predetermined threshold is set by a user via a user interface of the power tool 100. In some embodiments, the predetermined threshold is preprogrammed during manufacturing. In step 620, the method 600 includes determining, using the controller 405, that voltage across the DC bus 340 is greater than the predetermined threshold based on the comparison in step 615. In some embodiments, the controller 405 determines that the DC bus voltage is greater than or equal to the predetermined threshold. In some embodiments, the method 600 includes determining, using the controller 405, that the voltage across the DC bus 340 is greater than the predetermined threshold based on a leakage current across a MOSFET or other FET provided in the power circuit 300. For example, the FETs of the switching network 335 or the voltage clamp 330.

In step 625, the method 600 includes activating, using the controller 405, the voltage clamp 330. For example, the controller 405 outputs a first signal to a gate driver 410 to turn ON the transistor 415. The controller 405 activates the voltage clamp 330 in response to the DC voltage being greater than the predetermined threshold (the comparison in step 615). The controller 405 selectively activates the voltage clamp 330. In some embodiments, the controller 405 outputs the first signal to the gate driver 410 to turn ON the transistor 415 in response to activating the voltage clamp 330. In some embodiments, the controller 405 outputs a voltage (e.g., a pulse or a constant voltage) to the gate driver 410 such that the gate driver 410 turns the transistor 415 ON. In some embodiments, the gate driver 410 outs a PWM signal to the transistor 415 at a first frequency. For example, the first frequency of the PWM signal by be between 100 kHz-400 kHz. When the transistor 415 is turned ON, a power dissipating device, such as power dissipating device 420, is connected across the DC bus 425 and converts energy that is trapped into heat. When turned ON, the transistor 415 creates a current path through the power dissipating device 420, which gives the trapped energy (e,g., in the source inductor) a place to go (e.g., turning into heat). The power dissipating device 420 being connected across the DC bus 425 also limits the magnitude of the voltage of the DC bus to a first, acceptable level. For example, in a power tool 100 that operates around 18V, an acceptable level may be ±1V.

Thus, various embodiments described herein provide for power converter devices having wide bandgap semiconductors.

What is claimed is:

1. A power tool comprising:
a motor;
a DC bus configured to provide operating power to the motor;
a source inductor electrically connected to the DC bus;
a voltage clamp provided across the DC bus and configured to be selectively activated; and
a controller electrically connected to the voltage clamp, the controller configured to:
determine that a voltage across the DC bus is greater than a predetermined threshold, and
activate the voltage clamp in response to the voltage across the DC bus being greater than the predetermined threshold.

2. The power tool of claim 1, wherein the voltage clamp across the DC bus includes a gate driver, a transistor, and a power dissipating device.

3. The power tool of claim 2, wherein the transistor is a wide bandgap transistor.

4. The power tool of claim 2, wherein the controller is further configured to:
output, in response to activating the voltage clamp, a signal to the gate driver to turn the transistor on.

5. The power tool of claim 1, wherein activating the voltage clamp converts energy trapped in at least one of the source inductor and the motor to heat.

6. The power tool of claim 1 further comprising: a sensor configured to generate sensor data indicative of a voltage across the DC bus, wherein the sensor is electrically connected to the controller.

7. The power tool of claim 6, wherein the controller is further configured to:
determine that the power tool is in a shutdown mode,
receive the sensor data from the sensor, and
compare the sensor data to the predetermined threshold,
wherein the sensor data is indicative of the voltage across the DC bus.

8. The power tool of claim 7, wherein the shutdown mode is one of a controlled shutdown mode and an uncontrolled shutdown mode.

9. The power tool of claim 1, wherein the predetermined threshold is set via a user interface.

10. A method for converting trapped energy in a power tool to heat, the method comprising:
determining, using a controller, that a voltage across a DC bus of the power tool is greater than a predetermined threshold, and
activating, using the controller, a voltage clamp connected across the DC bus in response to the voltage being greater than the predetermined threshold.

11. The method of claim 10, wherein the voltage clamp across the DC bus includes a gate driver, a transistor, and a power dissipating device.

12. The method of claim 11, wherein the transistor is a wide bandgap transistor.

13. The method of claim 11, wherein the gate driver controls the transistor with a PWM signal.

14. The method of claim 11 further comprising:
outputting, using the controller, in response to activating the voltage clamp, a signal to the gate driver to turn the transistor on.

15. The method of claim 14, wherein the power dissipating device is connected across the DC bus converting trapped energy into heat and limiting a magnitude of the voltage across the DC bus to a first level.

16. A power circuit for providing power to a switching network to control a motor, the power circuit comprising:
a DC bus;
a source inductor electrically connected to the DC bus;
a voltage clamp; and
a controller electrically connected to the DC bus, the source inductor, and the voltage clamp, the controller configured to:
determine that a voltage across the DC bus is greater than a predetermined threshold, and
activate the voltage clamp in response to the voltage across the DC bus being greater than the predetermined threshold.

17. The power circuit of claim 16, wherein the voltage clamp across the DC bus includes a gate driver, a transistor, and a power dissipating device.

18. The power circuit of claim 17, wherein the controller is further configured to:
output, in response to activating the voltage clamp, a signal to the gate driver to turn the transistor on,
wherein activating the voltage clamp converts energy trapped in at least one of the source inductor and the motor to heat.

19. The power circuit of claim 17, wherein the voltage clamp includes a sensor configured to generate sensor data indicative of a voltage across the DC bus, wherein the sensor is electrically connected to the controller.

20. The power circuit of claim 19, wherein the controller is further configured to:
determine that a power tool is in a shutdown mode,
receive the sensor data from the sensor, and
compare the sensor data to the predetermined threshold,
wherein the sensor data is indicative of the voltage across the DC bus.
